(19) United States
(12) Patent Application Publication
(10) Pub. No.: US 2011/0142995 A1
(43) Pub. Date: Jun. 16, 2011

(54) COCONUT JUICE BEVERAGE WITH VITAMINS OR MINERALS OR BOTH

(76) Inventor: Kevin Hinds, Miami, FL (US)

(21) Appl. No.: 12/639,518

(22) Filed: Dec. 16, 2009

(51) Int. Cl. A23L 2/38; A23L 1/302; A23L 2/52

(52) U.S. Cl. 426/72; 426/598

(57) ABSTRACT

A beverage using coconut juice as a sole fluid base supplying water, fortified with one or more nutrients such as vitamins and minerals. The nutrient may be of a type which is insoluble in water, and has been artificially solubilized for compatibility with the fluid base. The beverage may be provided in concentrate form by removing some or all of the water present in natural coconut juice. The concentrate may be reconstituted by adding water obtained from a source other than the original coconut juice. The beverage or the concentrate may include non-nutritive components such as carbonation, sweeteners, preservatives, coloring agents, artificial flavors and fragrances.

### FIELD OF THE INVENTION

The present invention relates to beverages, and more particularly to beverages based on juice extracted from coconuts and fortified with vitamins or minerals or both.

### BACKGROUND OF THE INVENTION

Energizing and vitamin fortified beverages have become popular with the public. Fortified beverages are refreshing, and satisfy needs for hydration and vitamin and mineral supplements. Such beverages may utilize a base source of water such as spring water, distilled water, and natural juices.

### SUMMARY OF THE INVENTION

The present invention provides a fortified beverage based specifically and exclusively on coconut juice as a base source of water. The juice of fresh coconuts is blended with nutrients taken from the group including vitamins, minerals or any commonly known energy providing element. The vitamins, minerals and energy providing elements, where not naturally soluble in coconut juice, maybe solubilized for compatibility with coconut juice or simply held in suspension.

It is an object of the invention to provide improved beverages for the purposes described.

### DETAILED DESCRIPTION

The present invention is a beverage for human consumption, comprising a base liquid consisting solely of coconut juice, and at least one water soluble nutrient blended with the coconut juice. As user herein, “coconut juice” is intended to include not only the clear liquid which is contained within the center of coconuts, commonly known as, “coconut water,” but also may include the juice derived from the mashing of the pulp, commonly referred to as “coconut milk.” This liquid contains water and minor traces of substances of the coconut plant. As employed herein, a base liquid is a liquid which provides substantially all of the liquid intended to form the liquid basis of the beverage. Some water soluble nutrients may themselves inherently comprise a nominal amount of water, which will not appreciably or noticeably affect the total volume of water in the beverage. For the purposes of the present invention, blending implies a lasting mixing of water and other substances which resists spontaneous and rapid separation of the other substances from the water. The other substances may be dissolved in the water for example, or placed into a condition of long term emulsion or entrainment so that frequent mixing or stirring of the beverage are not required to assure that imbibed water includes the nutritive substances which have been added.

The water soluble nutrients are selected from the group consisting of vitamins, minerals, and energy providing elements. For the purposes of the present invention, minerals are those non-organic substances known to be critical to human health and body metabolism and development. Energy providing elements include those elements that not only provide energy, but any elements thought to have a healthful benefit and may include items such as, but not limited to: ginkgo biloba, Echinacea, ginseng, epigallocatechin gallate (egcg), taurine, leutine, glucosamine, and theanine.

The water soluble nutrients may comprise only one nutrient or substance, or if present as more than one nutrient or substance, will be referred to as a nutrient additive package. For example, a nutrient additive package may comprise two vitamins, more than two vitamins, two minerals, more than two minerals, or a combination including at least one vitamin and at least one mineral.

Some nutrients are inherently not initially water soluble, examples being those vitamins which are fat soluble but not water soluble. The novel beverage may comprise as part of the nutrient or nutrients provided one or more such nutrients which has been artificially solubilized. Solubilizing may comprise a chemical treatment or mixing with a solubilizing agent such as a detergent, which treatment or mixing has been intentionally performed to impart compatibility with water based liquids.

The invention may take the form not only of a beverage which is immediately ready for consumption, but also a concentrate for preparing a beverage which is similar to the novel beverage described above as having been prepared from coconut juice. The concentrate may comprise coconut juice processed to reduce natural water content thereof, and at least one water soluble nutrient blended with the processed coconut juice. Processing may be any suitable method which removes water content from natural coconut juice, such as evaporation under conditions of partial vacuum, passing coconut juice through a water impermeable filter, or any other process which does not impair the natural qualities of coconut juice apart from reducing water content. Processed coconut juice may be a syrup, or a liquid thickened from its natural state, a solid with all water removed, or any intermediate concentrated product.

An advantage of the concentrate is that the relatively high concentration of sugars and other natural constituents, such as organic acids, may act in the capacity of a preservative, for example by resulting in a pH which is inhospitable to microorganisms which otherwise could degrade the concentrate or beverage.

The concentrate may be reconstituted by adding a water containing fluid thereto. Depending upon the amount of water which was originally removed in processing for concentrate, added water is obtained from a source other than the original coconut juice. For example, added water may take the form of potable water, such as bottled water, tap water, distilled water, and the like, or may be a constituent of a mixture such as fruit juices, teas including herbal teas, milk, artificial beverages, and others. After addition of the added water, the resulting beverage may be called a reconstituted beverage.

The present invention is susceptible to modifications and variations which may be introduced thereto without departing from the inventive concepts. For example, the novel beverage or the concentrate for preparing a beverage may include added substances having a non-nutritive purpose. For example, the novel beverage may include carbonation, sweeteners, preservatives, coloring agents, artificial flavors and fragrances, and substances added for other purposes, in any combination thereof.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A beverage comprising:
a base liquid consisting solely of coconut juice, and at least one water soluble nutrient blended with in the coconut juice.

2. The beverage of claim 1, wherein the soluble nutrient comprises at least one of the group consisting of vitamins, minerals, and energy providing elements.

3. The beverage of claim 1, wherein the soluble nutrient comprises at least one vitamin and at least one mineral.

4. The beverage of claim 1, wherein at least one said soluble nutrient is not initially water soluble and has been artificially solubilized.

5. The beverage of claim 1, further comprising carbonation gas disposed in the coconut juice.

6. The beverage of claim 1, further comprising a preservative disposed n the coconut juice.

7. The beverage of claim 1, further comprising a coloring agent disposed in the coconut juice.

8. The beverage of claim 1, further comprising a sweetener disposed in the coconut juice.

9. The beverage of claim 8, wherein the sweetener is an artificial sweetener.

10. The beverage of claim 8, wherein the sweetener is a natural sweetener.

11. The beverage of claim 1, wherein the water soluble nutrient is held in suspension in the absence of a solubilizing agent.

12. A concentrate for preparing a beverage, comprising:
a base liquid consisting solely of coconut juice processed to reduce natural water content thereof; and
at least one water soluble nutrient blended with the processed coconut juice.

13. The concentrate of claim 12, further comprising water added to the concentrate, wherein the water is obtained from a source other than the original coconut juice, whereby the beverage is a reconstituted beverage.

14. A beverage consisting of coconut juice and a nutrient additive package blended with the juice of coconut, wherein the nutrient additive package comprises at least one of the group including vitamins, minerals, and energy providing elements.
